(19) United States
(12) Patent Application Publication
(10) Pub. No.: US 2002/0068479 A1
(43) Pub. Date: Jun. 6, 2002

(54) Tangless terminal fixed lock

(76) Inventors: John R. Morello, Warren, OH (US); Jon C. Hobbs, Burghill, OH (US)

Correspondence Address: Patrick M Griffin, Delphi Technologies Inc, P O Box 5052, Mail Code: 480-414-420, Troy, MI, 48007-5052, US

(21) Appl. No.: 09/543,225

(22) Filed: Apr. 5, 2000

(51) Int. Cl. H01R 13/40

(52) U.S. Cl. 439/595

(57) ABSTRACT

An electrical connector including a connector body having a secondary terminal hold-down member extending from an inside top surface of the connector body. The electrical connector body further including a primary terminal lock extending from an inside bottom surface. The electrical connector including a male terminal, wherein the male terminal has a locking surface on a bottom surface thereof. The electrical connector also including a primary terminal hold-down member fastened to a front outside surface of the connector body.

### TECHNICAL FIELD

The present invention relates to electrical connectors, and more particularly to electrical connectors having male terminals received in cavities of a connector body.

### BACKGROUND OF THE INVENTION

It is well known in the prior art to have an electrical connector that includes a male terminal received in a terminal cavity of a connector body. The male terminal is usually held in place within the connector body by flexible locking tangs or fingers. The flexible locking tangs or fingers generally are formed as part of the male terminal or the connector body. The manufacture of the connector bodies and male terminals of the prior art are complicated in that the numerous flexible locking tangs and fingers located on both the male terminal and the connector bodies are difficult to tool and injection mold. These structures often are large and bulky which require more material and time to complete the manufacturing operation. Another problem encountered in prior art devices is that the male terminal, once installed in the connector cavity, tends to come loose and become dislodged from the connector into which it was inserted. Therefore, there is a need in the art for an improved male terminal electrical connector that is easier to manufacture and provides better connectivity between the male terminal and the connector body.

### SUMMARY OF THE INVENTION

One object of the present invention is to provide a tangless terminal fixed lock.

Another object of the present invention is to provide an electrical connector having a secondary and primary male terminal hold-down member.

Yet a further object of the present invention is to provide an electrical connector that will not require fill material to enhance the terminal to connector retention force.

Yet a further object of the present invention is to provide an electrical connector that provides the maximum male terminal to connector body retention.

To achieve the foregoing objects, an electrical connector includes a connector body having a secondary terminal hold-down member extending from an inside top surface. The electrical connector further includes a primary terminal lock extending from an inside bottom surface of the connector body. The electrical connector also includes a male terminal which has a locking shoulder on a bottom surface thereof. The electrical connector also includes a primary terminal hold-down member connected to a front outside surface of the connector body.

One advantage of the present invention is an improved tangless terminal fixed lock electrical connector.

A further advantage of the present invention is an electrical connector having a secondary male terminal and primary male terminal hold-down member.

A further advantage of the present invention is an electrical connector that does not require fill material to enhance the terminal to connector retention force.

Still a further advantage of the present invention is an electrical connector that obtains maximum male terminal to connector retention by nonflexible securing techniques.

Another advantage of the present invention is an electrical connector that positively positions the male terminal with respect to the connector body floor.

Other objects, features and advantages of the present invention will become apparent from the subsequent description and appended claims, taken in conjunction with the accompanying drawings.

### BRIEF DESCRIPTION OF THE DRAWINGS

FIG. 1 shows a plan view of the present invention.

FIG. 2 shows a front view of the present invention in its multi-terminal embodiment.

FIG. 3 shows a cross section of the present invention taken along line A-A of FIG. 2.

FIG. 4 shows a cross section of the present invention taken along line B-B of FIG. 2.

### DESCRIPTION OF THE PREFERRED EMBODIMENT

Referring to the drawings, an electrical connector 10 according to the present invention is shown.

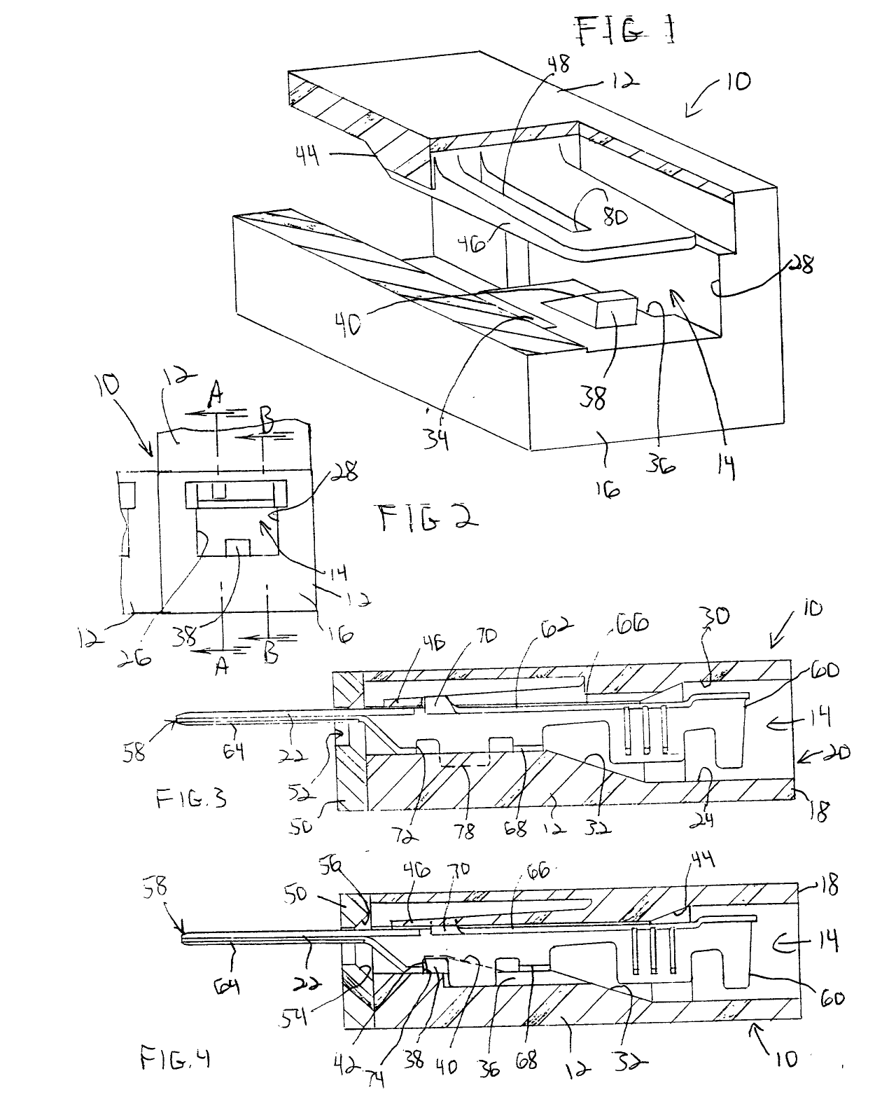

FIG. 1 shows the electrical connector 10 of the present invention which includes a connector body 12 having a terminal receiving cavity 14 formed therein. The connector body 10 includes a front face 16 and a rear face 18. The rear face 18 has an opening 20 which is aligned with the terminal receiving cavity 14 to facilitate insertion of a male or female terminal 22 into the cavity 14 through the rear face opening 20. In the preferred embodiment a male terminal 22 is used. The terminal receiving cavity 14 is defined in part by a floor 24 and opposed upright walls (26, 28) and a ceiling 30 extending between the opposed upright walls (26, 28). The cavity floor 24 includes an angled surface 32 rising from the rear portion of the floor to the front portion of the floor. The cavity floor 24 also includes a first channel 34 and a second channel 36 one on each side of the primary terminal locking nib 38. The primary terminal locking nib 38 also includes an inclined surface 40 and a defined lock shoulder portion 42. The ceiling 30 of the connector body 12 includes an inclined surface 44 which is angled towards the cavity floor 24. The cavity ceiling 30 also includes a secondary terminal hold-down member or cantilever beam 46 extending into the terminal receiving cavity 14 of the connector body 12. The secondary terminal hold-down member 46 includes a channel 48. The connector body 12 also includes a primary terminal hold-down member 50 which has an aperture 52 extending therethrough. The aperture 52 includes two angled inclined surfaces (54, 56) at a rear portion thereof.

The connector body 12 is constructed and arranged to receive a male terminal 22 in the terminal receiving cavity 14. It should be noted that a plurality of connector bodies 12 may be connected side by side or top to bottom to create a multi-terminal electrical connector for use in various electronic devices as shown in FIG. 2. The male terminal 22 may include a first 58 and second end 60, and a body portion 62 therebetween. The first end has an arm 64 which extends from the connector body 12 when properly inserted. The second end 60 is constructed for attachment to a wire and preferably includes a metal crimp section. The body portion 62 has a top surface 66 and a bottom surface 68. The top surface 66 includes an appendage 70 that extends upright from the top surface. The bottom surface 68 includes a recess or an aperture 72 formed therein for receiving the primary terminal lock nib 38. The bottom surface 68 also includes a locking edge 74 associated with the recess or aperture for engaging the locking shoulder 42 of the nib. The bottom surface 68 of the male terminal 22 also includes a first and second flange 78 that will slide along the first and second channels (34, 36) of the cavity floor surface.

To assemble the electrical connector 10, the first end 58 of the male terminal 22 is inserted through the opening in the rear face 20 of the connector body 12 and into the terminal cavity 14. The first end 58 of the male terminal 22 travels thought the entire terminal receiving cavity 14 and extends from the front face 16 of the connector body 12. The male terminal 22 will slide up the incline surface 32 on the bottom surface of the cavity floor and engage with the primary terminal lock nib 38. The male terminal 22 will slide on the primary terminal lock nib 38 until the primary terminal lock surface 74 engages with the primary terminal lock shoulder 42. At the same time the top surface 66 of the male terminal 22 will have its appendage 70 sliding within the channel 48 of the secondary terminal hold-down member 46. The secondary terminal hold-down member 46 has a wall 80 defining the end of the channel 48 and the appendage 70 will come to rest against the wall 80 of the secondary terminal hold-down channel 48. Once the male terminal 22 is in the locked position with regard to the primary terminal lock 38, the male terminal 22 is temporarily held down onto the cavity floor 24, in its locked position, by the secondary terminal hold-down member 46 which is applying a downward force on the male terminal 22. The secondary terminal hold-down member 46 is a flexible cantilever beam which allows the male terminal 22 to be plugged into the terminal receiving cavity 14 with very little resistance. Once the terminal cavity or cavities in the multi-terminal plug are filled, the primary terminal hold-down member 50 will be fastened to the front face 16 of the connector body 12. The primary terminal hold-down member 50 will either be fastened by an epoxy, glue or any other type of fastening means known in the art.

The primary terminal hold-down member 50 will positively position the male terminal 22 with respect to the cavity floor 24 by having the male terminal top surface in contact with the inner wall of the primary terminal hold-down member 50. It should be noted that primary terminal hold-down member 50 is a loose piece part which is fastened to the connector body 12 after insertion of the male terminal 22. Once the male terminal 22 is in its locked position, i.e. the male terminal lock surface 74 positioned relative to the shoulder of the primary terminal lock nib 38, the primary terminal hold-down member 54 will position the terminal 22 for maximum electrical connector cavity retention. This is accomplished because the lock features of the present invention are of a rigid nature. Furthermore, the electrical connector 12 of the present invention will not require a fill material to enhance the terminal to connector retention force. This will also increase the performance by having a maximum terminal to connector retention established with the only possibilities for failure being plastic shear or terminal deformation. Therefore, the present invention has increased male terminal retention while utilizing an unfilled nylon material for the connector body. It should be noted that any other type of plastic, ceramic or composite material may be used but with the preferred embodiment a nylon material is used.

The present invention has been described in an illustrative manner, it is to be understood that the terminology which has been used is intended to be in the nature of words of description, rather than of limitation.

Many modifications and variations of the present invention are possible in light of the above teachings. Therefore, within the scope of the appended claims, the present invention may be practiced otherwise than as specifically described.

1. An electrical connector, said connector including:
a connector body, said connector body having a terminal receiving cavity, said terminal receiving cavity being defined in part by a cavity floor and opposed walls, a primary terminal lock nib extending from said cavity floor, a flexible secondary terminal hold-down member extending into said terminal receiving cavity over said cavity floor, said connector body having a first and second face, said first face having a first opening in said terminal receiving cavity, said second face having a second opening for said terminal receiving cavity for insertion of a male terminal;
said male terminal having a first end and a second end, said terminal having a body between said ends, said body having a top surface and a bottom surface, said bottom surface having an aperture for receiving said primary terminal lock nib;
said male terminal being received in said terminal receiving cavity so that said primary terminal lock nib is engaged with said aperture of said male terminal, said male terminal is held down on said cavity floor in a locked position by said flexible secondary terminal hold-down member, said first face receives a primary terminal hold-down member after said male terminal is in said locked position, and said primary terminal hold-down member is fastened to said first face so that said male terminal is positively positioned with respect to said cavity floor.

2. The electrical connector of claim 1, wherein a plurality of said connector bodies are used to create a multi-terminal unit.

3. The electrical connector of claim 1 wherein said secondary terminal hold-down member includes a channel, said channel receives said male terminal.

4. The electrical connector of claim 1 wherein said primary terminal hold-down member positions said male terminal for maximum retention between said male terminal and said connector cavity.

5. The electrical connector of claim 3, wherein said male terminal having an appendage extending from said top surface thereof.

6. The electrical connector of claim 5 wherein said appendage slides within said channel.

7. The electrical connector of claim 1 wherein said secondary terminal hold-down member is a cantilever beam that allows for little resistance when said male terminal is received.

8. An electrical connector, said connector including:
a connector body, said connector body having a secondary terminal hold-down member extending from an inside top surface thereof,
a primary terminal lock extending from an inside bottom surface of said connector body;
a male terminal, said male terminal having a locking surface on a bottom surface thereof; and
a primary terminal hold-down member fastened to an outside surface of said connector body.

9. The electrical connector of claim 8 wherein said male terminal is inserted in said connector body and rides over said primary terminal lock into a locked position.

10. The electrical connector of claim 8 wherein said male terminal is temporarily held in place by said secondary terminal hold-down member.

11. The electrical connector of claim 8 wherein said secondary terminal hold-down member is a flexible cantilever beam.

12. The electrical connector of claim 11 wherein said secondary terminal hold-down member includes a channel.

13. The electrical connector of claim 12 wherein said male terminal having an appendage extending from a top surface thereof.

14. The electrical connector of claim 13, wherein said appendage slides within said channel.

15. The electrical connector of claim 8 wherein a said plurality of connector bodies are connected to create a multi-terminal unit.

16. The electrical connector of claim 8 wherein said primary terminal hold-down member is fastened to said connector body after said male terminal is inserted within said connector body.

17. The electrical connector of claim 16 wherein said primary terminal hold-down member positively position said male terminal with said inside bottom surface of said connector body.

18. The electrical connector of cliam 16 wherein said primary terminal hold-down member positions said male terminal for maximum retention to said connector body.

19. The electrical connector of claim 16 wherein said male terminal has maximum retention to said connector body without fill material.

20. The electrical connector of claim 8 wherein said primary terminal hold down member is a loose piece part.
